(19) United States
(12) Patent Application Publication
(10) Pub. No.: US 2024/0100449 A1
(43) Pub. Date: Mar. 28, 2024

(54) RACING TREE DEVICES, SYSTEMS, AND METHODS

(71) Applicant: SPEED PROMOTIONS PARTNERS LLC, Las Vegas, NV (US)

(72) Inventor: Samuel KORKIS, Susanville, CA (US)

(21) Appl. No.: 18/475,119

(22) Filed: Sep. 26, 2023

Related U.S. Application Data
(60) Provisional application No. 63/410,952, filed on Sep. 28, 2022.

(51) Int. Cl. A63K 3/02; G08G 1/095

(52) U.S. Cl. CPC A63K 3/02; G08G 1/095

(57) ABSTRACT

This disclosure relates generally to racing light and racing tree devices, systems, and methods. More particularly, this disclosure relates to racing tree and racing light devices, methods, and systems that include pre-stage lights, stage lights, and go lights for use in racing, such as for example drag racing. Embodiments of this disclosure omit traditional amber “warning” lights (i.e. the go lights are illuminated directly following the stage lights) to reward driver reaction speed.

### REFERENCE TO RELATED APPLICATIONS

This application claims the priority benefit of U.S. Provisional Patent Application No. 63/410,952, filed on Sep. 28, 2022 and entitled “RACING TREE DEVICES, SYSTEMS, AND METHODS,” which is fully incorporated by reference herein in its entirety.

### BACKGROUND OF THE INVENTION

### Field

This application is directed generally toward racing trees for use in conjunction with, for example, drag races, and toward associated devices, systems, and methods.

### Description of the Related Art

Racing trees or racing Christmas trees are devices used in racing, such as drag racing, for beginning the race. A typical prior art racing tree 100 is shown in FIG. 1. The prior art racing tree 100 includes left and right sides of lights 102,104 for the two lanes typical of a drag race, though it is understood that more lanes (and thus more light sets) are possible. The light sides are mounted on a frame 106. Each side includes one or more pre-stage lights 108, one or more stage lights 110, one or more amber lights 112 (in this case, three per side), a green light 114, and a red light 116.

In typical operation, the pre-stage lights 108 will be lit as the first driver passes within a certain distance of the starting line (e.g., 7 inches). Once the first driver reaches the starting line, the stage lights 110 are lit. When all drivers have reached the starting line and are fully staged, the amber lights 112 will light up in succession from top to bottom, followed by the green light 114, indicating that the drivers should start racing. A false start will trigger the red light 116.

### SUMMARY OF THE DISCLOSURE

One embodiment of a racing tree according to the present disclosure includes one or more light sets, each of said light sets includes one or more pre-stage lights, one or more stage lights, and a go light, with the go light configured to light directly after the stage light.

One embodiment of a method according to the present disclosure includes lighting one or more pre-stage lights of a racing tree when one or more cars reaches a certain distance from a starting line, lighting one or more stage lights when one or more of the cars reaches the starting line, and at a randomized time within a pre-set time range after all of the stage lights are lit, lighting one or more go lights.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIG. 1 shows a prior art racing tree;

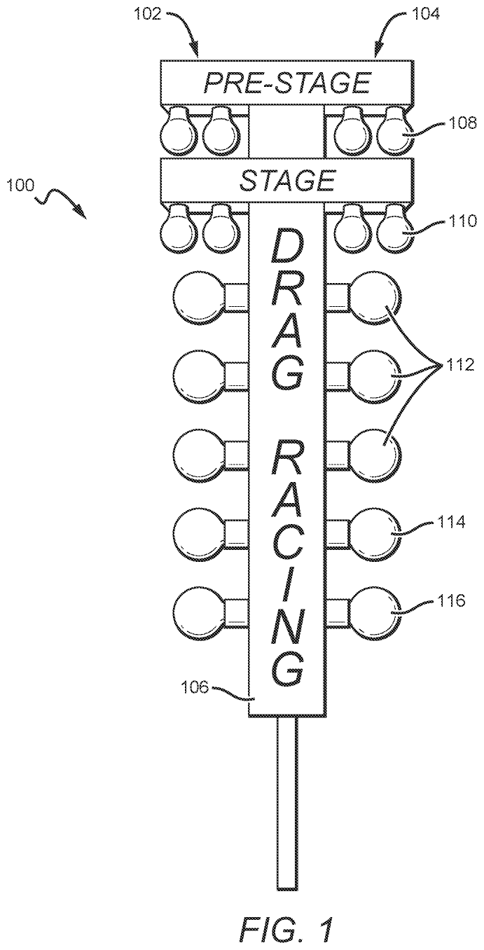

FIG. 2 shows a race setup and a racing tree according to one embodiment of the present disclosure; and

FIG. 3 shows a race setup and a racing tree according to another embodiment of the present disclosure.

### DETAILED DESCRIPTION OF THE INVENTION

The present application describes racing systems, trees, and methods. Specifically, the present application pertains to a racing tree that omits the traditional amber lights that light up prior to the green “go” light, and instead has the “go” light activate directly after the stage light (i.e., without any meaningful intervening light(s)). The present application also describes related systems, devices, and methods.

Throughout this description, the preferred embodiment and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

### Racing System and Tree

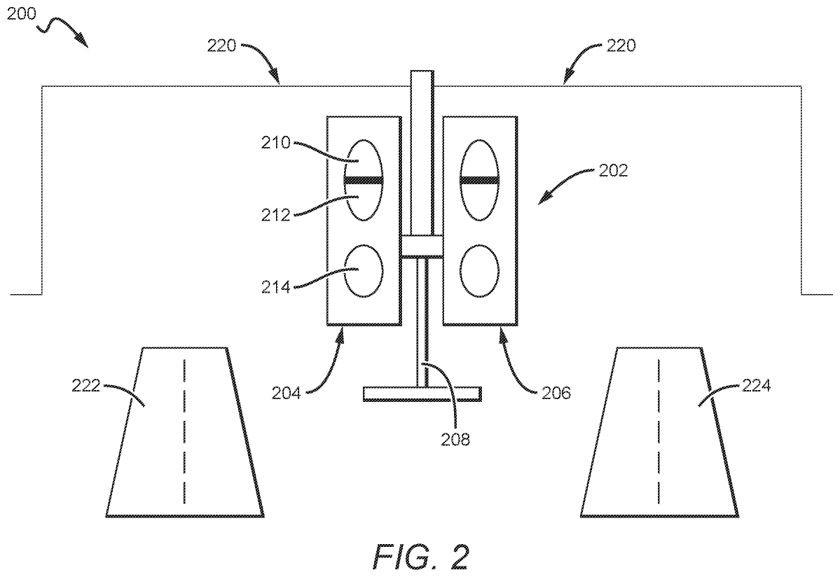

One embodiment of a racing system 200 with a racing tree 202 according to the present disclosure is shown in FIG. 2. The racing tree 202 can be portable or stationary, and/or can be fixed to another structure. The racing tree 202 includes two sides of lights 204,206, though it is understood that any number of sets of lights is possible (e.g. 1, 2 or more, 3 or more, etc.). Each side 204,206 can include one or more pre-stage lights 210, one or more stage lights 212, and a go light 214 (collectively, “the lights”). The lights can be mounted on a frame 208. The racing system 200 includes a left lane 222 and a right lane 224 (referred to together herein as “the lanes”). It is understood that fewer or more sides of lights are possible, and in one embodiment a light set is used for each lane (e.g. 3 light sets for 3 lanes, 4 light sets for 4 lanes, etc.). In the racing system 200 shown in FIG. 2, the left light side of lights 204 can be used by a car (not shown) in the left lane 222. Similarly, the right side of lights 206 can be used by a car (not shown) in the right lane 224.

In this specific embodiment, the pre-stage lights 210 and stage lights 212 are the same color and are red, though it is understood that they can be a non-red same color, or can be different colors. Also in this specific embodiment, each pre-stage light 210 forms a shape with its respective stage light 212. The shape can be bifurcated/divided (as shown) or non-bifurcated/non-divided. In this specific embodiment the shape is an oval, but it is understood that other non-oval shapes are possible, such as but not limited to circles, squares, rectangles, triangles, regular and irregular polygons, and other shapes. Many different embodiments are possible.

The go light 214 can be any color/shape combination. In this specific embodiment, it is a green circle or oval shape.

Additional or fewer lights are also possible. For instance, in one embodiment, the system and/or tree includes a light indicating that the system is ready. In another embodiment, the pre-stage lights are omitted. Many different embodiments are possible. In some embodiments, a false start light is included (not pictured in FIG. 2), which can be illuminated if a car begins racing before the go light is illuminated.

The racing system 200 can also include a truss, frame, or similar structure 220 (referred to hereinafter as a “truss” for simplicity). The truss 220 can be over a race tracks (e.g., the lanes 222,224) and can connect to the racing tree 202, such as to the frame 208. Wiring (including but not limited to traditional wiring, cabling, etc.) can run along the truss 220 from the tree 202, such as running in both directions and over the lanes 222,224, so that the wiring can then run down-track (in FIG. 2, into the page) to the outside of the lanes 222,224. It is understood that in other embodiments the wiring may run down the inside of the lanes 222,224, or some combination of inside/outside.

The wiring running down-track can be used to gather information about a race, such as speed and time, at certain intervals. For instance, in one embodiment, it gathers information at a short distance from the start line (e.g. 60 feet), a quarter of the way down the track (e.g. 330 feet for a standard quarter mile track), and/or halfway down the track (e.g. 660 feet). It is understood that numerous different embodiments with varying intervals are possible, and any number of measuring points (0, 1, 2 or more, 3 or more, etc.) are possible. The measurements can be taken using, for instance, one or more lasers, RFID technology such as RFID chips, sensors such as SBL1 sensors with or without reflectors, and other measurement taking devices as would be understood by one of skill in the art.

A finish light can be included for each lane, such as a green light. The green light can be connected to the above-described wiring. The finish light of the racer that crosses the finish line first can light up, while the other one or more finish lights remain dark.

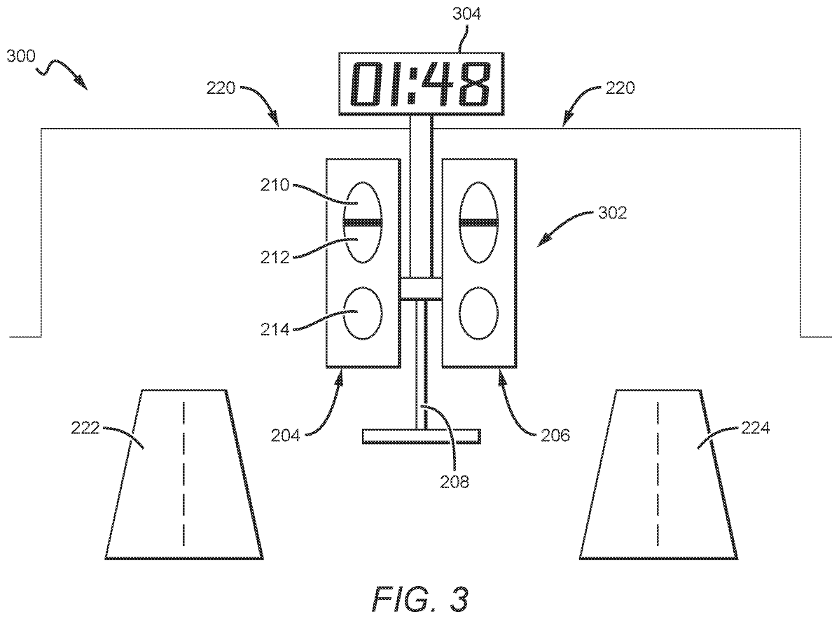

FIG. 3 shows an alternative embodiment of a system 300 including a racing tree 302. The racing tree 302 can be similar to or the same as the racing tree 202, but this embodiment also includes a clock or timer 304 (referred to hereinafter as a “clock” for simplicity). In some embodiments the clock 304 can be used for a single purpose, while in other embodiments it can toggle between purposes. One example purpose is time-telling (i.e., the clock will inform viewers of the current time). Another purpose is to act as a timer. For instance, the clock 304 can count down the time which a racer has to line up, reach pre-stage position, or reach stage position. In one embodiment the timer begins once the first racer enters a burnout box or staging area; in another embodiment, after the final racer enters the burnout box or staging area. For instance, in some embodiments, racer(s) can be given 30 seconds to 5 minutes, or 1 to 3 minutes, or about 2 minutes, or 5 minutes or less, or 3 minutes or less, or 2 minutes or less. It is understood that these uses and time ranges are exemplary in nature, and many different embodiments are possible. In some embodiments, the clock 304 is attached to and/or incorporated into the frame 208. The clock 304, in some embodiments, is connected to the wiring.

### Operation

As each car pulls up to the starting line and reaches a certain distance of the starting line (e.g. 3 inches to 2 feet, or 4 to 10 inches, or about 7 inches), its respective pre-stage light 210 can light up. As each car reaches the starting line, its respective stage light 212 can light up. It is understood that in other embodiments, one or more other pre-stage lights 210 may light up once the first car or the last car is within a certain distance of the start line, and/or all stage lights 212 may light up once the first car or the last car reaches the start line.

Once all stage lights 212 are lit and/or once all cars are at the start line, a random timing system can be used to determine when the go lights 214 will light up to signal the beginning of the race. This varies from the prior art in that there are no warning lights such as the amber lights 112 between the lighting of the stage lights 212 and the lighting of the go lights 214. This can be advantageous in that it can prevent or lessen the effectiveness of racers anticipating or timing the start, so as to more effectively test each racer's reaction time. The timing between the lighting of the stage lights 212 and the go lights 214 can be randomized, and can be within any number of ranges. For instance and not by way of limitation, the timing could be randomized within a range of 0 seconds to 10 seconds, or 0.1 seconds to 5 seconds, or 0.25 seconds to 2.5 seconds, or 0.3 seconds to 3 seconds, or 0.4 seconds to 2 seconds, or 0.2 seconds to 2 seconds, or 0.4 seconds to 1.5 seconds, or 0.2 seconds to 1 second, or 0.4 seconds to 1 second, or any combination of the low end and high end of the above ranges, or any range with its low end and high end within the above ranges (inclusive of outer limits). It is understood that these ranges are exemplary in nature and other ranges are possible.

In an alternative embodiment, the time between the lighting of the stage lights 212 and go lights 214 can be pre-set.

If a racer leaves early/false starts, the tree 202 can signal this in any number of ways. For instance, in one embodiment, the pre-stage and/or staging lights 210,212 on the false start side can flash. In another embodiment, the tree 202 includes a false start light that illuminates in the event of a false start. It is understood that many other embodiments are possible.

The system can be controlled electronically, such as using a tablet, computer, mobile phone, or other device as known in the art. The controller can monitor functions of the various sensors (e.g. RFID, lasers, etc.) and/or the tree 202,302 in order to ensure they are functioning properly, and/or can log data from races.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

I claim:

1. A racing tree, comprising:
one or more light sets, each of said light sets comprising:
a pre-stage light;
a stage light; and
a go light, said go light configured to light directly after said stage light.

2. The racing tree of claim 1, comprising two of said light sets.

3. The racing tree of claim 1, wherein said light sets are on a frame.

4. The racing tree of claim 1, wherein said pre-stage light is red.

5. The racing tree of claim 1, wherein said stage light is red.

6. The racing tree of claim 1, wherein said go light is configured to light at a random time within a pre-set time range after said stage light is lit.

7. The racing tree of claim 1, wherein in each of said light sets, said pre-stage light and said stage light form a shape.

8. The racing tree of claim 7, wherein said shape is an oval.

9. The racing tree of claim 7, wherein said shape is divided.

10. The racing tree of claim 9, wherein said pre-stage light is a top portion of said shape and said stage light is a bottom portion of said shape.

11. The racing tree of claim 1, wherein said pre-stage light is configured to provide an indicator if a racer false starts.

12. The racing tree of claim 11, wherein said indicator is said pre-stage light flashing.

13. The racing tree of claim 1, wherein said stage light is configured to provide an indicator if a racer false starts.

14. The racing tree of claim 13, wherein said indicator is said stage light flashing.

15. The racing tree of claim 1, further comprising a clock.

16. The racing tree of claim 15, further comprising a frame, wherein said clock is attached to said frame.

17. A method for a racing tree, comprising:
lighting one or more pre-stage lights of a racing tree when one or more cars reaches a certain distance from a starting line;
lighting one or more stage lights when one or more of said cars reaches said starting line; and
at a randomized time within a pre-set time range after all of said stage lights are lit, lighting one or more go lights.

18. The method of claim 17, wherein said one or more go lights are lit directly after said one or more stage lights.

19. The method of claim 17, wherein said pre-set time range is within 0 to 10 seconds.

20. The method of claim 17, further comprising flashing said pre-stage lights and/or said stage lights when a car false starts.
